(19) United States
(12) Patent Application Publication
(10) Pub. No.: US 2025/0194587 A1
(43) Pub. Date: Jun. 19, 2025

(54) COMPOSITION AND METHOD FOR REDUCING SPRAY DRIFT

(71) Applicant: NUFARM AUSTRALIA LIMITED, Victoria (AU)

(72) Inventors: Sumit SHARMA, Victoria (AU); Simon HARBOTTLE, Victoria (AU)

(21) Appl. No.: 19/070,457

(22) Filed: Mar. 4, 2025

Related U.S. Application Data
(63) Continuation of application No. 17/254,209, filed on Dec. 18, 2020.

(30) Foreign Application Priority Data
Jun. 22, 2018 (AU) 2018902238

(51) Int. Cl. A01N 25/02; A01N 25/30; A01N 37/40; A01N 39/04; A01N 57/20

(52) U.S. Cl. CPC A01N 25/02; A01N 25/30; A01N 37/40; A01N 39/04; A01N 57/20

(57) ABSTRACT

An aqueous pesticidal solution concentrate for spray application comprising a water-soluble pesticide salt and a drift reduction agent comprising a protein and a fatty acid.

This application is a continuation of U.S. patent application Ser. No. 17/254,209, which is a national stage application under 35 U.S.C. § 371 of International Application No. PCT/AU2019/050628, filed Jun. 19, 2019, which claims priority benefit to Australia Application No. 2018902238, filed Jun. 22, 2018.

### FIELD

The invention relates to an aqueous pesticidal solution concentrate for spray application having reduced spray drift, to a method of preparing the solution concentrate and to a method of reducing spray drift using the concentrate.

### BACKGROUND

The possibility of off target spray drift from the application of pesticides is a concern to the agriculture industry and the community. Off-target movement as a result of spray drift has the potential to adversely affect neighbouring crops and cause adverse environmental effects. Furthermore spray drift may necessitate the use of more chemicals to achieve the required pest control in the desired area than would otherwise be needed.

Spray drift is caused by airborne movement particularly of the fine droplets produced by spray nozzles and is exacerbated by evaporation and wind shear of droplets. The small droplets of size less than 150 microns, particularly less than 105 microns, may travel significant distances.

Spray drift may be controlled by the addition of additives to the spray tank in which the pesticide concentrate is diluted with water prior to spray application. High molecular weight polymers such as polysaccharide gums, polyacrylamides, polyethylene oxide and other synthetic polymers have been used as drift control agents. Such polymers may be difficult to disperse in an aqueous solution concentrate and can result in blocking of spray nozzles. They are also often not compatible with water-soluble salt pesticides due to the formation of gels with the pesticide. Esterified seed oils and mineral oils have also been examined but generally cannot readily be incorporated in solution concentrates without compromising the stability of the concentrate and/or the diluted concentrate prepared prior to spray application.

It would be useful to include drift control agents in the pesticide concentrate so that it is present in an amount with respect to the pesticide to provide a predetermined level of drift control. The use of drift control agents in a concentrate presents additional problems due to the need to provide stability of the concentrate on storage. The presence of much higher loadings of the pesticide and any adjuvants than in the diluted concentrate for spraying also exacerbates issues of incompatible components which can lead to phase separation, precipitation, gel formation or an unacceptably high viscosity for convenient dispensing of the concentrate. Furthermore, incorporation of a drift control agent in a concentrate runs the risk of problems such as phase separation or precipitation occurring when the concentrate is diluted prior to spray application of the diluted concentrate. The problems which occur on dilution are frequently exacerbated by the variable quality of water used in agricultural settings.

There is a need for a drift control agent which can be used in pesticide solution concentrates.

### SUMMARY

We have found that the combination of a protein and fatty acid in an aqueous pesticide concentrate allows a stable formulation to be provided in the concentrate and on dilution and has a favourable impact on the atomisation performance of the diluted solution providing a significant drift reduction on spray application of the diluted concentrate. Accordingly there is provided an aqueous pesticidal solution concentrate for spray application comprising a water-soluble pesticide salt and a drift reduction agent comprising a protein and a fatty acid wherein the concentration of fatty acid is at least 5 g/L.

The aqueous pesticidal solution concentrate may be an aqueous solution concentrate of a water-soluble pesticide salt such as an organic pesticide in the form of a water-soluble salt. The invention is particularly suitable for control of drift for organic acid pesticides such as carboxylic, phosphonic and sulfonic acid pesticides in the form of a water-soluble salt selected from alkali metal salts, ammonia and amine salts.

The invention further provides a method for pest control using the aqueous pesticidal solution concentrate comprising diluting the aqueous pesticidal solution concentrate with water and applying the diluted concentrate by spray application to the locus of pests to be controlled.

### DETAILED DESCRIPTION

The term pesticide where used herein includes insecticides, fungicides, herbicides, miticides, nematicides, plant growth regulators and mixtures thereof generally applied in the form of a liquid composition. Preferred pesticides for use in the concentrate of the invention are nematicides, plant growth regulators and herbicides, particularly herbicides. The pesticide is a water-soluble pesticide salt such as selected from salts of herbicidal acids, plant growth regulators and nematicides. The more preferred pesticides are water-soluble salts of herbicidal acids and in particular water-soluble salts of auxin herbicides such as water-soluble salt of one or more herbicides selected from the group consisting of benzoic acid herbicides, phenoxyacetic acid herbicides, phenoxybutyric acid herbicides, pyridine carboxylic acid herbicides, phenoxypropionic acid herbicides and picolinic acid herbicides.

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereof.

The term “spray-mixture” refers to the herbicide concentrate composition in a liquid diluent, particularly water, suitable for spray application. The spray-mixture may contain adjuvants such as surfactant and spray-oils which are either part of the herbicide concentrate, added during preparation of the spray-mixture or both.

The term “water-soluble pesticide” as used herein includes any pesticide which is water-soluble at the concentration used in the concentrate. Typically the water-soluble pesticide, such as the water soluble salt of a herbicidal acid, will have a solubility in pure water of at least 50 g/L, such as 100 g/L, at least 150 g/L, at least 200 g/L, at least 300 g/L, at least 500 g/L or at least 600 g/L at a temperature of 25° C.

The term “fatty acid” describes aliphatic monocarboxylic acids. Various embodiments include fatty acids having an aliphatic hydrocarbon chain of known naturally occurring fatty acids are generally unbranched and contain an even number of from about 6 to about 24 carbons, from about 8 to 22 and others include fatty acids having from 12 to 18 carbons in the aliphatic hydrocarbon chain. Embodiments of the invention encompass naturally occurring fatty acids as well as non-naturally occurring fatty acids, which may contain an odd number of carbons. Thus, in some embodiments of the invention fatty acids have an odd number of carbons of, for example, from 7 to 23 carbons, and in other embodiments, from 11 to 19 carbons.

The aliphatic hydrocarbon chain of fatty acids of various embodiments may be unsaturated. The term “unsaturated” refers to a fatty acid having an aliphatic hydrocarbon chain that includes at least one double bond and/or substituent. In contrast, a “saturated” hydrocarbon chain does not include any double bonds or substituents. Thus, each carbon of the hydrocarbon chain is ‘saturated’ and has the maximum number of hydrogens.

The term “adjuvant” as used herein is a broad term, and is to be given its ordinary and customary meaning to a person of ordinary skill in the art (and is not to be limited to a special or customized meaning), and refers without limitation to an agent that modifies the effect of other agents and more particularly used to enhance the effectiveness of the pesticide, or modify the physical characteristics of the mixture.

The pesticide concentrate typically comprises an aqueous liquid carrier. The term liquid carrier is used to refer to the aqueous carrier not including the fatty acid or protein or adjuvants such as surfactants. The liquid carrier may be water and optionally a co-solvent in an amount of from about 0 wt % to about 50 wt % of the liquid carrier. In some embodiments the presence of a co-solvent such as an alcohol or glycol is useful to assist in stabilising the concentrate composition depending on the concentration of the pesticide and its water solubility. In the case of water-soluble salts of auxin herbicides a co-solvent may not be required or if present, the amount may generally be limited, for example to no more than 5 wt % of the liquid carrier.

Fatty acids may be in the form of salts such as at least one of alkali metal salts (particularly lithium, potassium or sodium salts or mixtures of such salts), ammonia salts or amine salts, Further the fatty acid may comprise a mixture of different individual fatty acids such as those mixtures commonly found in naturally occurring fatty acids. It will also be understood that depending on the pH and presence of counter ions in solution various fatty acid salts may form in solution.

The pesticidal solution concentrate comprises a water-soluble pesticide salt active and a drift reduction agent comprising a protein and a fatty acid.

The pesticide active is water-soluble or in a water-soluble form and the solution concentrate is an aqueous solution concentrate, that is, the active is present in solution. The pesticide may be present in the form of a water-soluble salt such as a salt of a pesticidal acid formed with an alkali metal, a nitrogen base such as selected from ammonia and amines or mixture thereof.

The concentration of the pesticide in the pesticidal solution concentrate will depend on the solubility and efficacy of the pesticide. Typically the pesticide will be present in an amount of at least 50 g/L, such as at least 100 g/L, at least 150 g/L, at least 200 g/L, at least 300 g/L, at least 400 g/L or at least 500 g/L. In the case of a pesticide in the form of the water-soluble salt of a pesticidal acid the corresponding concentration of the salt may be expressed in terms of the grams of acid equivalent of the salt per litre of solution concentrate.

The drift reduction agent includes a protein and a fatty acid. The concentration of protein and fatty acid in the composition will depend on the presence of other components and the extent of drift reduction required in the proposed spray application of the composition, including the extent of dilution with water which is to be used in spray application of the pesticide. In one set of embodiments the drift reduction agent comprises protein in an amount of up to 100 g/L, preferably up to 30 g/L, such as from 0.1 g/L to 30 g/L, 0.5 g/L to 20 g/L or 1 g/L to 15 g/L and fatty acid in an amount of up to 300 g/L such as 5 g/L to 300 g/L, 10 g/L to 300 g/L, 20 g/L to 250 g/L or 50 g/L to 250 g/L. It will be appreciated that in the diluted composition formed for spraying of the pesticide, the concentration of the drift reduction agent is very significantly reduced from that in the concentrate.

The preferred fatty acids are C₆ to C₂₂ fatty acids or salt thereof and may be a saturated or unsaturated fatty acid. In one set of embodiments the fatty acid is a C₈ to C₂₂ fatty acid or salt thereof, preferably C₁₄ to C₂₀ fatty acid or salt thereof or their combinations. Examples of C₆ to C₂₂ fatty acid or salt thereof include oleic acid, ricinoleic acid, linoleic acid, hexanoic acid, lauric acid, decanoic acid, pelargonic acid, stearic acid, salts thereof and mixtures thereof. In one set of embodiments the fatty acid is ethylenically unsaturated. Unsaturated C₁₆ to C₂₀ fatty acids (particularly C₁₆ to C₁₈ fatty acids) have been found to perform well in reducing spray drift in combination with protein. For example in specific examples we have found to be effective the pesticidal solution concentrate has a fatty acid selected from oleic acid, ricinoleic acid, linoleic acid, salts thereof and mixtures thereof.

The pesticidal solution concentrate includes, as part of the drift reduction agent, a protein. Proteins from a range of sources may be used such as plant and animal proteins. Examples of proteins are milk proteins (such as casein, sodium casein, calcium casein, lactalbumin, dried milk, whey protein), plant protein (such as gluten, e.g. from wheat; soy extract, peanut extract, zein), animal protein (such as fish, meat and egg proteins). Examples of particularly suitable proteins may be selected from casein, albumin, lactalbumin, whey protein, soy protein isolate, cereal protein or salts or combinations thereof. Sodium caseinate has been found to be a convenient choice for the protein component of the drift reduction agent.

The pesticidal solution concentrate may contain the combination of protein and fatty acid in a range of ratios and the optimum ratio of protein:fatty acid can readily be determined for a specific solution concentrate. In one set of embodiments the weight ratio of the protein to fatty acid is in the range of from 1:500 to 1:1 and preferably from 1:100 to 1:5.

The pesticide active present in the pesticidal solution concentrate is generally soluble in an aqueous concentrate. Co-solvents may be present to improve solubility if desired. In one set of embodiments the pesticide active is a water-soluble pesticide in the form of a salt of a pesticidal acid with a suitable cationic counterion. Examples of such pesticides comprise an acid group such as carboxylic acid, phosphonic acid, sulfonic acid or the like and the pesticide may comprise a counter ion such as selected from alkali metals, ammonia and amines.

Examples of alkali metal counter ions include sodium, potassium and lithium.

In one embodiment the pesticide salt is a salt of an acid pesticide such as an auxin herbicide, formed with a nitrogen base. The nitrogen bases may be selected from a range of compounds such as those of formula I:

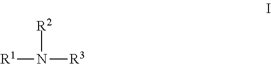

wherein:

R¹ is selected from the group consisting of hydrogen, C₁ to C₁₀ alkyl, C₁ to C₁₀ alkanol and C₁ to C₁₀ amino alkyl;

R² and R³ are independently selected from the group consisting of hydrogen, C₁ to C₆ alkyl, C₁ to C₆ alkanol, C₁ to C₆ amino alkyl and the group wherein R² and R³ together complete a 5 or 6 membered heterocyclic ring containing the nitrogen in formula I and optionally a further heteroatom selected from O and N as a ring member and optionally substituted by C₁ to C₆ alkyl. Examples of compounds of formula I in which R² and R³ complete a heterocyclic ring include piperazine, morpholine and the N-alkyl derivatives thereof.

At least one nitrogen base is preferably present and in one embodiment includes at least one selected from the group consisting of ammonia, C₁ to C₁₀ alkylamine, di-(C₁ to C₆ alkyl)amine, tri-(C₁ to C₆ alkyl)amine, C₁ to C₁₀ alkanolamine, C₁ to C₆ alkyl (C₁ to C₆ alkanol)amines and di-(C₁ to C₆ alkyl) (C₁ to C₆ alkanol)amines.

The nitrogen bases, in one set of embodiments contains at least one selected from the group consisting of ammonia, C₁ to C₁₀ alkylamine, di-(C₁ to C₄ alkyl)amine, tri-(C₁ to C₄ alkyl)amine, C₁ to Co alkanolamine C₁ to C₄ alkyl (C₁ to C₄ alkanol)amines and di-(C₁ to C₄ alkyl) (C₁ to C₄ alkanol)amines.

In another embodiment the amines include cycloaliphatic amines such as 5 and 6 membered aliphatic rings comprising at least one ring nitrogen and optionally another heteroatom such as nitrogen or oxygen and optionally substituted.

Specific examples of readily available nitrogen bases include those selected from the group consisting of ammonia, methylamine, dimethylamine, trimethylamine, ethylamine, diethylamine, triethylamine, propylamine, dipropylamine, tripropylamine, isopropylamine, diisopropylamine, butylamine, dibutylamine, tributylamine, isobutylamine, diisobutylamine, triisobutylamine, 1-methylpropylamine (D, L), bis(1-methyl) propylamine (D,L), 1,1-dimethylethylamine, pentylamine, dipentylamine, tripentylamine, 2-pentylamine, 3-pentylamine, 2-methylbutylamine, 3-methylbutylamine, bis(3-methylbutyl)amine and tris (3-methylbutyl)amine, diglycolamine, isophorone diamine and aminomethylpiperazine.

In a further embodiment the pesticide active comprises an acid group such as such as carboxylic acid, phosphonic acid, sulfonic acid or the like and the pesticide comprises a counter ion which is a quaternary amine such as quaternary amines of Formula II

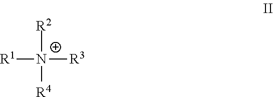

wherein R¹, R² and R³ are as defined for Formula I and R⁴ is as defined for R¹ of Formula I. Specific Examples of quaternary amines include tetra (C₁ to C₄ alkyl)amines such as tetramethylammonium.

In a preferred set of embodiments the water-soluble pesticide salt is present in an amount of at least 50 g/L and up to 750 g/L, preferably at least 150 g/L and up to 750 g/L, more preferably at least 300 g/L, such as at least 500 g/L wherein the amount is based on the pesticidally active ion, such as the acid equivalent (gae/L).

The pesticide present in the pesticidal solution concentrate is one embodiment is a herbicide, preferably a water-soluble herbicide such as a salt of a herbicidal acid where the herbicide may, for example be in the form of a salt of carboxylic acid, phosphoric, phosphonic and sulfonic acid group present in the herbicide.

The salt of an acid herbicide may be selected from salts of one or more selected from the group consisting of aromatic acid herbicides, organo phosphorous herbicides, thiadiazinone, phenoxy alkanoic acid herbicides, aryloxy-phenoxy alkanoic acid herbicides, picolinic acid herbicides, quinolone carboxylic acid herbicides and mixtures of two or more thereof. More preferred herbicides are auxin herbicides such as aromatic acid herbicides, phenoxy alkanoic acid herbicides, picolinic acid herbicides and mixtures of two or more thereof.

The salt counter ion may be, for example an alkali metal salt such as a potassium or sodium salt or a nitrogen salt counter ion such as ammonia, or an amine such as a primary tertiary or quaternary amine salt. Specific examples of amine counter ions are of formula I described above.

Specific examples of readily available nitrogen bases include, but are not limited to, those selected from the group consisting of ammonia, methylamine, dimethylamine, trimethylamine, ethylamine, diethylamine, triethylamine, tetramethylamine, propylamine, dipropylamine, tripropylamine, isopropylamine, diisopropylamine, butylamine, dibutylamine, tributylamine, isobutylamine, diisobutylamine, triisobutylamine, 1-methylpropylamine (D, L), bis(1-methyl) propylamine (D,L), 1,1-dimethylethylamine, pentylamine, dipentylamine, tripentylamine, 2-pentylamine, 3-pentylamine, 2-methylbutylamine, 3-methylbutylamine, bis(3-methylbutyl)amine, tris (3-methylbutyl)amine, N,N-bis(3-aminopropyl)methylamine, diglycolamine, isophoronediamine and aminopiperazine, monoethanolamine, diethanolamine, triethanolamine, propanolamine, ethylamine, benzylamine, triisiopropanolamine, butylisopropanolamine, N-(β-aminoethyl) ethanolamine, N-methylmonoethanolamine, N-ethylmonoethanolamine, N-butylmonoethanolamine, N-methyldiethanolamine and N-butyldiethanolamine aminomethylpropanolamine, 2-Amino-2-methyl-1,3-propanediol and 2-Amino-2-(hydroxymethyl) propane-1,3-diol.

Specific examples of the preferred nitrogen bases may be selected from the group consisting of ammonia, methylamine, isopropylamine, dimethylamine, diethylamine, diisopropylamine, triethylamine, triisopropylamine, dimethylethanolamine and diglycolamine.

In one particular embodiment, the pesticide comprises at least one water-soluble salt of an acid herbicide selected from the group consisting of benzoic acid herbicides, imidazolinones, thiadiazinone, phenoxyacetic acid herbicides, phenoxy butyric acid herbicides, phenoxy propionic acid herbicides, picolinic acid herbicides and organophosphorus herbicides, benzoic acid herbicides, imidazolinones, thiadiazinone, phenoxyacetic acid herbicides, phenoxy butyric acid herbicides, phenoxy propionic acid herbicides, picolinic acid herbicides and particularly 2,4-D, dicamba, aminopyralid, clopyralid, picloram, halauxifen, flopyrauxifen, dichlorprop, mecoprop, dichlorprop-P, mecoprop-P, bentazone, imazamox, imazapyr, glyphosate, and glufosinate.

Particularly suitable water-soluble herbicides include auxin herbicides including water-soluble salts of 3,6-dichloro-2-methoxybenzoic acid (dicamba), 2,4-D, clomeprop; dichlorprop; diclorprop-P, MCPA; MCPB; mecoprop; mecoprop-P; chloramben; TBA, picloram, clopyralid, aminopyralid and mixtures of two or more thereof.

In one embodiment the composition comprises a mixture of two or more herbicides selected from the group consisting of 3,6-dichloro-2-methoxybenzoic acid (dicamba), 2,4-D, clomeprop; dichlorprop; diclorprop-P, MCPA; MCPB; mecoprop; mecoprop-P; chloramben; TBA, picloram, clopyralid or aminopyralid. Specific examples of such mixtures include (a)dicamba, dichlorprop-P and 2,4-D; (b) MCPA and mecoprop-P; (c)dicamba and dichlorprop-P; (d) 2,4-D and dichlorprop-P and e) 2,4-D and mecoprop-P.

The pesticidal solution concentrate in one set of embodiments comprises a water-soluble herbicide salt of a herbicidal acid wherein the herbicide salt is present in an amount of at least 50 g/L such as at least 100 g/L, at least 150 g/L, at least 200 g/L, at least 300 g/L, at least 500 g/L or at least 600 g/L and typically up to 750 g/L, based on herbicidal acid equivalent per litre of solution concentrate (gae/L).

The invention is particularly suited to use with the pesticidal solution concentrate pesticide is selected from salts of 2,4-D, dicamba and mixtures thereof, wherein the salts are selected from amine salts. One specific example of such compositions include the auxin herbicide composition of U.S. Pat. No. 9,179,673 the contents of which are herein included by reference and which discloses aqueous liquid herbicide compositions comprising a solution of 2,4-D and/or dicamba auxin herbicides, which have monomethylamine and dimethylamine counter ions where the molar ratio of monomethylamine to dimethylamine is in the range of from 20:1 to 1:1, preferably from 20:1 to 7:3, and even more preferably from 20:1 to 4:1. 1:20 to 4:6, and the concentration of auxin herbicide is at least 500 g/L based on herbicidal acid equivalent.

The water-soluble pesticides include certain nematicides, and plant growth regulators. Exemplary water-soluble nematicides which may be employed in the present invention include: water-soluble salts of 3,4,4-trifluoro-3-butenoic acid and N-(3,4,4-trifluoro-1-oxo-3-butenyl)glycine.

Exemplary water-soluble plant growth regulators which may be employed in the present invention include water-soluble salts of Ethephon, gibberellic acid, glyphosine, maleic hydrazide, mefluidide, 1-naphthalene acetic acid and triiodobenzoic acid.

The water-soluble insecticides may, for example include water-soluble organophosphorus insecticides such as acephate and methamidophos.

One skilled in the art will readily appreciate that these pesticides exhibit sufficient water solubility that they will dissolve when mixed with water at the labelled use rate.

The pesticide component of the composition may comprise mixtures of pesticides for controlling different pest types such as mixtures of two or more of weeds, and nematodes. In one embodiment the pesticide may comprise a mixture of herbicides such as salts of two or more herbicide acids selected from the group consisting of benzoic acid herbicides, imidazolinones, phenoxyacetic acid herbicides, phenoxy butyric acid herbicides, phenoxy propionic acid herbicides, pyridine carboxylic acid herbicide, picolinic acid herbicides and organophosphorus herbicides and particularly water-soluble salts of two or more of 2,4-D, MCPA, dicamba, aminopyralid, clopyralid, picloram, halauxifen, flopyrauxifen, dichlorprop, mecoprop, dichlorprop-P, mecoprop-P, imazamox, imazapyr, bentazone, glyphosate and glufosinate. The use of the combination may provide improved utility of the application. Specific examples of mixtures include mixtures of salts of glyphosate and salts of one or more of benzoic acid herbicides, imidazolinones, phenoxyacetic acid herbicides, phenoxy butyric acid herbicides, phenoxy propionic acid herbicides, pyridine carboxylic acid herbicides, picolinic acid herbicides and organophosphorus herbicides and particularly 2,4-D, MCPA, dicamba, aminopyralid, clopyralid, picloram, halauxifen, flopyrauxifen, dichlorprop, mecoprop, imazamox, imazapyr. In another embodiment the mixture comprises two or more of 2,4-D, MCPA, dicamba, aminopyralid, clopyralid, picloram, halauxifen, flopyrauxifen, dichlorprop, mecoprop, dichlorprop-P, mecoprop-P, imazamox and imazapyr.

The concentrate composition may, if desired contain a co-solvent such as in an amount of up to 50 wt % of the aqueous liquid carrier such as. The co-solvent in some embodiments is thus from 0 wt % to 50 wt % of the aqueous liquid carrier such as 0 wt % to 35 wt %, 0 wt % to 30 wt % or 0 wt % to 25 wt %. In many cases such as for certain highly water-soluble auxin salts a high loading of herbicide acid equivalent may be obtained without the use of a co-solvent so that water is the only liquid carrier, though a co-solvent may be used if desired. Water solubility may vary significantly depending on the nature of the salt counter ion and/or the pesticide acid and in some cases a co-solvent may assist in obtaining suitable stability for the desired loading of pesticide. Accordingly in some embodiments such as for certain water-soluble salts of auxin herbicides the co-solvent may be no more than 5 wt % or no more than 2 wt % and the composition may be free of co-solvent. In other embodiments the presence of co-solvent may be advantageous to stability of the composition and the co-solvent may be present in an amount such as 5 wt % to 35 wt % or 15 wt % to 30 wt % depending on the loading and water solubility of the pesticide.

The nature of any co-solvent may be chosen based on the pesticide. It is found in some cases that alcohol solvents or glycols are useful.

The concentrate composition may if desired contain surfactant which may be selected from anionic, cationic, non-ionic, amphoteric and mixtures thereof. Typically the surfactant component will comprise no more than 15 wt % (such as 0 wt % to 10 wt %) or no more than 10 wt % (such as 0 wt % to 5 wt %) of the composition. In many cases such as salts of auxin herbicides it may be preferred to have little or no surfactant in order to optimise the pesticide loading.

The pesticidal solution concentrate comprises a fatty acid. The fatty acid is present in the solution concentrate in at least 5 g/L. Typically the fatty acid is present in an amount of up to about 300 g/L. We have found, as hereinafter demonstrated, that very small amounts of fatty acid such as 0.1 wt % are ineffective in controlling spray drift whether or not used in combination with a protein such as casein. Preferably the fatty acid is present in an amount of 10 g/L to 300 g/L, such as 20 g/L to 250 g/L or most preferably 50 g/L to 250 g/L. The protein may be present in an amount of from 0.1 g/L to 100 g/L, preferably from 0.5 g/L to 20 g/L, more preferably from 1 g/L to 15 g/L, such as 1 g/L to 10 g/L.

We have found that the effectiveness of the drift reduction agent and stability may vary with the pH of the composition where the pH is determined as a 1% sample of solution concentrate in water. Generally, the pH is in the range of from 3.5 to 9 preferably from 5.5 to 8.0.

The pesticidal solution concentrate composition on dilution and spray application forms a spray in which fine spray in which the proportion of droplets smaller than 150 μm, particularly less than 105 μm, in diameter is decreased below that of a composition that does not include drift reduction component when tested at application rates used for pesticidal control.

The invention further provides a method for pest control using the aqueous pesticidal solution concentrate comprising diluting the aqueous pesticidal solution concentrate with water and applying the diluted concentrate by spray application to locus of pests to be controlled.

The method involves application of a spray-mixture formed by dilution of the aqueous herbicidal solution concentrate to the locus of weeds to be controlled. The optimum rate at which the spray-mixture is applied will depend on the specific formulation, the herbicide and any adjuvants present which may influence the efficacy of the herbicide. In one set of embodiments the method comprises applying the spray-mixture at a rate of application per hectare of herbicide in the range 30 gae/ha to 5000 gae/ha, particularly 40 gae/ha to 2000 gae/ha, such as 100 gae/ha to 1000 gae/ha.

In one set of embodiments the method comprises applying the spray-mixture formed from the concentrate having a concentration of herbicidal salt of 0.01 wt % to 20 wt % preferably 1 wt % to 10 wt %.

In one set of embodiments the method comprises a step of forming a spray-mixture of the herbicide by mixing the concentrate composition, with a spray adjuvant, particularly a spray oil and diluent, typically water. Examples of spray oils include paraffinic spray oils, vegetable derived oils such as vegetable oils and esters of vegetable oils such as methyl and ethyl esters of vegetable oils. In one embodiment the spray oil contains an oil such as paraffin oil naphtha-based petroleum oil, vegetable based oil in an amount such as 50% to 98% oil and, one or more surfactants such as 1 wt % to 40 wt % functioning as emulsifiers and/or wetting agents. In another embodiment the spray oil may contain 60 to 85% of emulsifiable oil such as paraffin oil naphtha-based petroleum oil, vegetable based oil and 15 to 40% of nonionic surfactants. In one embodiment, the spray oil comprises a paraffinic oil.

Products correctly identified as “vegetable oil concentrates” typically consist of 60 to 85% of vegetable oil (i.e. seed or fruit oil, most commonly from cotton, linseed, soybean or sunflower) and 15 to 40% of nonionic surfactants. Adjuvant performance can be improved by replacing the vegetable oil with esters such as methyl or ethyl esters of fatty acids that are typically derived from vegetable oils. The amount of oil-based adjuvants added to the spray-mixture generally does not exceed about 2.5% by volume, and more typically the amount is from about 0.1 to about 1% by volume. The application rates of oil-based adjuvants added to the spray-mixture are typically between about 250 ml to 5 L per hectare such as 1 L to about 5 L per hectare, and methylated seed oil-based adjuvants in particular are typically used at a rate from about 1 L to about 2.5 L per hectare.

Spray adjuvants containing oils, with or without emulsifiers, particularly methylated seed oils or ethylated seed oils, are particularly compatible in spray-mixtures. Therefore one embodiment of the present invention relates to a mixture or method for controlling weeds, further comprising forming the spray-mixture. The step of forming of the spray-mixture may involve mixing the concentrate composition with water and optionally an adjuvant. In a preferred aspect an adjuvant such as a spray oil, which may be a crop oil concentrate or vegetable oil concentrate such as an esterified seed oil such as methylated or ethylated seed oil is used. The method may involve adding an adjuvant (in any order of addition or mixing) to the spray-mixture, and contacting the crop with an amount of the spray-mixture effective to control the target weeds.

The ratio of the volume of the concentrate to the volume of water used to dilute the concentrate, is generally in the range from about 1:10 to about 1:5000, more typically from about 1:20 to about 1:2000. The amount of diluted spray-mixture needed for effective control depends upon a variety of factors including the concentration of the concentrate, presence and concentration of any other adjuvants, the extent of dilution in water. These conditions can be determined by calculation and simple experimentation by one skilled in the art.

In one set of embodiments the spray oil comprises a fatty acid or fatty acid derivative such as a methyl of ethyl ester derivative that enhances the penetration of herbicide into the weed. The spray oil may comprise a surfactant that is non-ionic, anionic or cationic in nature. In one embodiment the spray oil includes a non-ionic surfactant such as an alkoxylated alky alcohol surfactant. In one preference, the concentration of the spray oil in spray water is in the range 200 ml to 1000 ml spray oil per 100 L of water, preferably in the range 300 ml to 700 ml/100 L water, still more preferably about 500 ml/100 L water.

In a further embodiment the method may comprise including a further herbicide in the spray-mixture by a method step known in the art as tank-mixing. For example in one embodiment the method comprises formation of spray-mixture from a concentrate of the invention comprising an auxin herbicidal salt and a tank mixed further active or adjuvant which may be a herbicide, insecticide, fungicide, plant growth regulating agent, safener, ammonium sulfate or liquid fertiliser. Tank mixing of a herbicide may involve a herbicide selected from the group consisting of a further auxin herbicide such as those referred to above and organophosphorus herbicides such as glyphosate, glufosinate and glufosinate-P.

The invention will now be described with reference to the following examples. It is to be understood that the examples are provided by way of illustration of the invention and that they are in no way limiting to the scope of the invention.

### EXAMPLES

Where referred to in the Examples the concentration of pesticide salt form of a salt of a pesticide acid is based on the concentration of acid equivalent.

### Example 1 (Comparative Example)

Aim: To prepare and evaluate aqueous formulations containing 2,4-D DMA MMA salt containing various oils.

TABLE 1
Trial mixtures containing 2,4-D DMA MMA aqueous salt
and various oils (1Stock containing 4 g/L casein and
700 g/L 2,4-D as DMA MMA salt soluble concentrate).

| | | | | |
|---|---|---|---|---|
| Stock¹ | 106.0 | 106.0 | 106.0 | 106.0 |
| 2,4-D Amine (g) | | | | |
| Methylated | 10.0 | nil | nil | nil |
| seed oil (g) | | | | |
| Ethylated | nil | 10.0 | nil | nil |
| seed oil (g) | | | | |
| Canola Oil (g) | nil | nil | 10.0 | nil |
| Paraffinic oil (g) | nil | nil | nil | 10.0 |
| Water | To 100 ml | To 100 ml | To 100 ml | To 100 ml |
| Appearance | Hazy. | hazy | hazy | Hazy |
| of mixture | | | | |

| | |
|---|---|
| Observation | All the mixtures (undiluted) exhibited phase separation |
| | on storage. The mixtures also showed phase separation |
| | when added to tap water (5% v/v dilution). |

The concentration of 2,4-D in the stock solution is 56.72% w/w. Casein is present in the stock in an amount of 0.324% w/w.

Procedure: Physical mixtures containing oils and 2,4-D DMA MMA stock formulation as shown in Table 1 were prepared. The required quantity of 2,4-D amine stock and oils were transferred to 100 ml volumetric flasks and made up to volume with tap water. Volumetric flasks were shaken to mix the contents. Mixtures were checked for physical appearance and tested for dilution properties at 5% v/v dilution in tap water.

### Observation.

All the mixtures (as shown in Table 1) were hazy in appearance indicating insolubility of oils in 2,4-D DMA MMA aqueous solution. All the mixtures showed phase separation on storage. These mixtures also exhibited phase separation when added to tap water at 5% v/v dilution and therefore were not suitable formulations.

Further formulations trials using surfactants were carried out in an attempt to stabilise oil containing 2,4-D amine compositions.

### Example 2 (Comparative Example)

Aim: To prepare and evaluate aqueous formulations containing 2,4-D DMA MMA salt containing surfactant and oils.

TABLE 2
Trial mixtures containing 2,4-D DMA MMA aqueous salt, various
oils and surfactant (2Stock containing 4 g/L casein and
700 g/L 2,4-D as DMA MMA salt soluble concentrate).

| | | | | |
|---|---|---|---|---|
| Stock² | 180.0 | 180.0 | 180.0 | 180.0 |
| 2,4-D Amine (g) | | | | |
| Non-ionic | 10.0 | 10.0 | 10.0 | 10.0 |
| surfactant | | | | |
| Methylated | 20.0 | nil | nil | nil |
| seed oil (g) | | | | |
| Ethylated | nil | 20.0 | nil | nil |
| seed oil (g) | | | | |
| Canola Oil (g) | nil | nil | 20.0 | nil |
| Paraffinic oil (g) | nil | nil | nil | 20.0 |
| Water | To 200 ml | To 200 ml | To 200 ml | To 200 ml |
| Appearance | Slightly | Slightly | Slightly | Slightly |
| of mixture | hazy | hazy | hazy | hazy |

| | |
|---|---|
| Observations | All the mixtures exhibited phase separation on storage |
| | and were not stable |

Procedure: Physical mixtures containing oils, surfactant and 2,4-D DMA MMA stock formulation as shown in Table 2 were prepared. The required quantity of 2,4-D amine stock and oils were transferred to 200 ml volumetric flasks and made up to volume with tap water. Volumetric flasks were shaken to mix the contents. Mixtures were checked for physical appearance and homogeneity on storage.

### Observation.

All the mixtures containing aqueous 2,4-D DMA MMA, surfactant and oils were unstable and separated rapidly. The trial results showed that oils and lipid cannot readily be incorporated in 2,4-D amine aqueous without compromising the stability of the concentrate and the dilution properties of the formulation.

### Example 3 (Comparative Example)

Trial with Polymer

A composition containing aqueous 2,4-D DMA MMA and synthetic Polyethylene oxide polymer was also attempted as shown in Table 3.

TABLE 3
Trial mixtures containing 2,4-D
DMA MMA aqueous salt and polymer.

| | |
|---|---|
| 2,4-D g/L (present as | 500 |
| the DMA and MMA salts | |
| Casein (g/L) | 4.0 |
| Polyethylene oxide (g/L) | 0.62 |
| Water | To 1000 ml |
| Observation | Mixture showed |
| | precipitation on storage |

### Procedure

0.62 g of Polyethylene oxide added to 150 ml of water and allowed to gently stir until hydrated, resulting in a homogenous, viscous solution. Casein was added to the solution along with 2,4-D, DMA and MMA and allowed to stir until a homogeneous solution was achieved. Finally this solution was made to 1 L with water.

### Observations

Mixture exhibited development of precipitation upon storage and hence was not a stable combination.

### Example 4

Aim: To assess the miscibility of oleic acid in 2,4-D DMA MMA aqueous concentrate.

Procedure: Stock formulation containing 700 gae/L 2,4-D as dimethylamine and monomethylamine and 4 g/L casein was used in this trial. Physical mixtures containing fatty acid in the form of oleic acid (Palmac 750 with 72% w/w C18:1) and 2,4-D DMA MMA stock formulation as shown in Table 4 were prepared. The required quantity of 2,4-D stock formulation was transferred to 20 ml glass vials. Magnetic fleas were then added to the vials and were set to stir at low speed. While stirring, the required quantity of oleic acid was then added drop wise to each vial.

The combinations were mixed for 30 minutes and were monitored for physical appearance. Visual inspection showed the solutions to be clear with no signs of cloudiness, separation or precipitation at room temperature. The mixtures were tested for dilution properties and produced stable dilutions.

TABLE 4
Trial mixtures containing varied amount of 2,4-D DMA MMA aqueous
salt and oleic acid. (4Stock containing 4 g/L casein and
700 g/L 2,4-D as DMA MMA salt soluble concentrate).

| | | | Physical | Appearance of 5% |
|---|---|---|---|---|
| | Stock⁴ | Oleic | appearance of | dilution in |
| | 2,4-D Amine | Acid | the neat | tap water (at |
| Mixture # | (g) | (g) | mixture | 30 minutes) |
| 1 | 9 | 1 | clear | clear |
| 2 | 8 | 2 | clear | hazy |
| 3 | 7 | 3 | clear | hazy |

The concentration of 2,4-D in the stock solution is 56.72% w/w. Casein is present in the stock in an amount of 0.324% w/w.

### Observation and Comments

Mixtures 1 to 3 (as shown in table 4) resulted in a clear physical mixture with no visible solids.

All the combinations were tested for dilution stability (5% v/v in Melbourne tap water of Nominal 20 ppm hardness). Mixtures #2 and #3 formed particularly effective emulsions on dilution.

Considerable reduction of amine odour was achieved by addition of oleic acid in stock formulation containing 2,4-D DMA MMA. The reduction in amine odour in mixture #1 was slight. The amine odour in mixture #2 and #3 was significantly reduced as compared to 2,4-D amine without oleic acid.

The characteristics of mixture #2 were preferable and therefore was further evaluated for physical parameters.

### Example 5

A further formulation mixture containing 50% w/v 2,4-D as DMA MMA salt (as in Table 5) was prepared based on mixture #2 as shown in Table 4.

Preparation and evaluation of a 200 mL mixture containing 500 g/L 2,4-D as the DMA MMA salt and 25% w/v oleic acid and characterisation of associated spray droplet distribution.

TABLE 5
Physical mixture containing 50% w/v 2,4-D as DMA
MMA salt. (5 Stock containing 4 g/L casein and 700
g/L 2,4-D as DMA MMA salt soluble concentrate).

| Ingredients | Quantity |
|---|---|
| Stock⁵ 2,4-D Amine (g) | 180.0 g |
| Oleic Acid | 50.6 |

A 200 ml mixture was prepared as shown in Table 5 by mixing Stock 2,4-D amine and oleic acid in a glass beaker using magnetic stirrer. A clear solution was achieved after 10 minutes of mixing. The mixture was tested for physical parameters as shown in Table 6.

TABLE 6
Physical parameters of a mixture containing 50% w/v
2,4-D as DMA MMA salt and 25.3% w/v oleic acid.

| Appearance | | Amber coloured, clear liquid. |
|---|---|---|
| pH 1% in DI water | | 6.76 |
| pH neat | | 6.84 |
| Density kg/L | | 1.143 |
| Odour | | Negligible |
| Persistent foam | | 20 ml in 60 seconds |
| Viscosity | At 20° C. | 132 cP @ 30 RPM |
| | At 5° C. | 390 cP @ 10 RPM |

Dilution Stability

| Timepoint | Std A | Std D | Std C | 3 WHO |
|---|---|---|---|---|
| Initial | Strike cloudy | Strike cloudy | Strike cloudy | Strike cloudy |
| 30 minutes | Cloudy, no | Cloudy, no | Cloudy, no | Cloudy, no |
| | separation, no | separation, no | separation, no | separation, no |
| | oil, no | oil, no | oil, no | oil, no |
| | crystallisation, | crystallisation, | crystallisation, | crystallisation, |
| | no precipitation. | no precipitation. | no precipitation. | no precipitation. |
| 2 hours | Cloudy, no | Cloudy, no | Cloudy, no | Cloudy, no |
| | separation, no | separation, no | separation, no | separation, no |
| | oil, no | oil, no | oil, no | oil, no |
| | crystallisation, | crystallisation, | crystallisation, | crystallisation, |
| | no precipitation. | no precipitation. | no precipitation. | no precipitation. |
| 24 hours | Cloudy, no | Cloudy, no | Cloudy, no | Cloudy, no |
| | separation, no | separation, no | separation, no | separation, no |
| | oil, no | oil, no | oil, no | oil, no |
| | crystallisation, | crystallisation, | crystallisation, | crystallisation, |
| | no precipitation. | no precipitation. | no precipitation. | no precipitation. |

Spray droplet size analysis of Table 5 Composition.

The Table 5 composition was diluted in tap water to achieve a final concentration of 1.4% v/v, equivalent to 7 g/L 2,4-D acid, representing a field application rate of 700 g.a.e/ha 2,4-D at 100 L/ha water. The test solution was sprayed using a flat fan nozzle XR11002 nozzle at 3.0 Bar pressure. The resulting spray droplet distribution was analysed using an Oxford Laser imaging system equipped with VisiSize software. The instrument was set up to acquire images of a section of the spray pattern at 30 cm directly below the spray nozzle. The images are processed to obtain an accurate size for all droplets recorded within this section of the spray pattern to obtain a spray droplet distribution specific to the nozzle, pressure and fluid combination being analysed. The cumulative volume percent of the measured droplet distribution that contains droplets of diameter<105 μm is defined as the driftable fraction.

The driftable fraction of test solutions is compared to the driftable fraction of water (unless specified otherwise) at a matched nozzle and pressure set up.

The driftable fraction of Table 5 composition diluted at 1.4% v/v in water was measured along with that of a 2,4-D DMA MMA soluble concentrate comparison reference diluted to the same final concentration of 2,4-D. The results are shown in Table 7.

TABLE 7
Driftable fraction of 2,4-D DMA MMA stock and test solution
of mixture prepared as per Table 5 as compared to water.

| | | Test | Change in cumulative |
|---|---|---|---|
| | | Rate | volume %<105 μm as |
| Test Solution | Description | (% v/v) | compared to water |
| 2,4-D DMA | Experimental aqueous formulation | 1.0 | +20.2% |
| MMA control | containing 700 g/L 2,4-D DMA MMA | | |
| Formulation as | 500 g/L 2,4-D DMA MMA plus | 1.4 | −66.1% |
| per Table 5. | 250 g/L Oleic Acid & 3 g/L casein | | |

### Observation and Comments on Evaluation of Composition of Table 5.

The Table 5 composition was found to have satisfactory physical and dilution properties. Emulsion stability tested in lab tap water (nominally 20 ppm hardness), CIPAC Std D (342 ppm hardness), CIPAC Std C (500 ppm hardness) and in 3 WHO (1000 ppm hardness) water was good.

The amine odour of Table 5 composition was significantly reduced as compared to standard 2,4-D DMA MMA soluble concentrate solution comparison reference.

The measured driftable fraction of the diluted formulation was significantly less than that of standard 2,4-D DMA MMA soluble concentrate comparison reference.

### Example 6a: Further Trials and Observations

Based on the satisfactory initial physical properties of the composition of Table 5, a 1 L batch of the same composition was prepared from the individual raw materials.

The scaled up 1 L batch was not completely clear in appearance and had a slight haze.

To investigate the formation and the impact of observed haziness, two further formulations were prepared, one formulation containing casein (Formulation #1) and one without casein (Formulation #2) as shown in Table 5. Both formulation #1 and #2 contained 500 g/L 2,4-D DMA MMA with 25% w/v oleic acid.

A further two formulations were prepared containing 500 g/L 2,4-D as the DMA MMA salt, casein and varying quantities of Oleic Acid to assess the impact of fatty acid concentration on formulation appearance. (Formulation #3 and Formulation #4, Table 8).

### Formulation Examples #1 to #4

TABLE 8
Formulation #1, #3 and #4: 2,4-D DMA MMA aqueous
formulation with oleic acid and casein. Formulation #2: 2,4-D
DMA MMA aqueous formulation with oleic acid and no casein.

| | Formulation | | Formulation | | Formulation | | Formulation | |
|---|---|---|---|---|---|---|---|---|
| Component | #1 | | #2 | | #3 | | #4 | |
| 2,4-D acid technical | 510.20 | g | 510.20 | g | 510.20 | g | 510.20 | g |
| (98.0 wt %) | | | | | | | | |
| Monomethylamine (40% | 35.14 | g | 35.14 | g | 35.14 | g | 35.14 | g |
| aqueous solution) | | | | | | | | |
| Dimethylamine (60% | 136.0 | g | 136.0 | g | 136.0 | g | 136.0 | g |
| aqueous solution) | | | | | | | | |
| Casein | 4.0 | g | NIL | | 4.0 | g | 4.0 | g |
| Oleic Acid | 250.0 | g | 250.0 | g | 180.0 | g | 150.0 | g |

| | | | | |
|---|---|---|---|---|
| Water | To 1 L | To 1 L | To 1 L | To 1 L |

Preparation for Formulation #1, #3 and #4 (formulation with casein and oleic acid).

Formulation containing 500 g acid equivalent of 2,4-D as DMA and MMA salt, casein, oleic acid and water was prepared. 100 g of water was added to a beaker followed by slow addition of required quantity of DMA (60% aqueous solution) and MMA (40% aqueous solution) to the beaker. Content was mixed at low agitation using an overhead stirrer. While stirring, the required amount of casein was added to the beaker. Once casein was dissolved, 2,4-D acid technical (98.0% wt/wt) was gradually added to the beaker. After addition of all the base and 2,4-D acid technical, the content was mixed to achieve a clear solution. Oleic acid was then added to the beaker and mixed to obtain a clear solution. Mixture was transferred to 1 L volumetric flask and made to volume with water of nominal 20 ppm hardness. Resulting formulations were slightly hazy, free from visible solid particulate matter.

Note 1: Formulations were also prepared in which casein was pre-dissolved in alkaline base and added to 2,4-D DMA MMA oleic acid solution. Formulations prepared using pre-dissolved casein were clear and free from visible solid particulate matter.

Note 2: The amount of alkaline base used to dissolve 2,4-D acid technical may vary due to volatile losses during manufacture. Excess bases may be required to completely neutralise 2,4-D technical material.

Preparation for Formulation #2 (comparative formulation without casein).

Formulation containing 500 g acid equivalent of 2,4-D as DMA and MMA salt, oleic acid and water was prepared. 100 g of water was added to a beaker followed by slow addition of required quantity of DMA (60% aqueous solution) and MMA (40% aqueous solution) to the beaker. Content was mixed at low agitation using an overhead stirrer. While stirring, the required amount of 2,4-D acid technical (98.0% wt/wt) was gradually added to the beaker. After addition of all the base and 2,4-D acid technical, the content was mixed to achieve a clear solution. Oleic acid was then added to the beaker and mixed to obtain a clear solution. Mixture was transferred to 1 L volumetric flask and made to volume with water of nominal 20 ppm hardness.

Note: The amount of alkaline base used to dissolve 2,4-D acid technical may vary due to volatile losses during manufacture. Excess bases may be required to completely neutralise 2,4-D technical.

### Properties of Formulations #1, #2 (Comparative), #3 and #4.

TABLE 9
Physical parameters of Formulation #1 to #4.

| Property | Formulation #1 | Formulation #2 | Formulation #3 | Formulation #4 |
|---|---|---|---|---|
| Appearance | Amber coloured | Amber coloured | Amber coloured | Amber coloured |
| | liquid | liquid | liquid | liquid |
| pH 1% in DI water | 6.94 | 6.81 | 6.68 | 7.01 |
| Density kg/L | 1.136 | 1.137 | 1.148 | 1.152 |
| Dilution Properties | Good in all | Good in tap | Good in all | Good in all |
| (Diluted in tap water, | water qualities | water and | water qualities. | water qualities. |
| 342, 500 and 1000 | | 342 ppm. | | |
| ppm) | | Crystallisation | | |
| | | in 500 and | | |
| | | 1000 ppm. | | |
| Driftable Fraction as | −62.8% | −2.6% | −61.8% | −44.8% |
| compared to that of | | | | |
| water. | | | | |

### Observations for Formulations #1-#4.

The dilution testing of Formulation #1 and #2 showed a difference in dilution properties. Upon dilution, Formulation #1, containing casein, resulted in an opaque/milky white liquid instantaneously. The formulation without casein formed a translucent, see through liquid on dilution.
The measured driftable fractions for Formulations #1 & #2 (comparative) when diluted at 1.4% v/v in water were significantly different. Formulation #1, containing casein, resulted in a 63% reduction in the driftable fraction, whereas Comparative Formulation #2, without casein, did not significantly change the driftable fraction in comparison to that of water under the same conditions. (Table 9).

Formulation #3 and #4 were tested at 1.4% v/v dilution rate for their resultant driftable fraction upon atomisation. Formulation #3 reduced the driftable fraction to an equivalent extent as that of Formulation #1, however the reduction in driftable fraction was not as significant for Formulation #4 which contained the lowest quantity of oleic acid.

### Conclusion (Formulations #1 to #4).

Formulation #1 to #4 were prepared and evaluated for physical parameters and droplet size distribution. Obtained results showed an effectiveness of casein and oleic acid in 2,4-D DMA MMA formulation as an in—can drift reduction system. Formulations prepared with and without casein exhibit significant differences in spray droplet size distributions. 2,4-D DMA MMA oleic acid aqueous formulations comprising casein and Oleic Acid showed a considerable reduction in driftable fraction. There was no significant reduction in driftable fraction in the formulation without casein. It was also found that casein is critical to achieve acceptable dilution properties in hard water.

### Evaluation of Component Interactions and Effects on Spray Properties.

To evaluate the contributions of oleic acid and casein on the formulations spray properties, and the magnitude of any interactions present, a factorial design of experiment model was utilised. The model contained three variables, each at two levels, and all measurements were compared to that of a ‘Blank’ solution consisting of 2,4-D amine with no casein and no oleic acid.

Constant-540 g/L 2,4-D DMA MMA salt at 1:1 stoichiometric acid to base ratio.

Variable A: Amine Content-Level one=10% molar excess, Level 2=20% molar excess.

Variable B: Casein-Level one=2 g/L, Level 2=8 g/L

Variable C: Oleic Acid-Level one=100 g/L, Level 2=250 g/L

‘Blank’ solution=700 g/L 2,4-D DMA MMA salt solution with 15% molar excess.

Each of the formulations was diluted with water to a concentration of 7 g/L 2,4-D and sprayed from a Teejet AIXR11003 Nozzle at 2.75 Bar. The cumulative volume %<105 μm was measured.

TABLE 10
Factorial design:

| | | | | | | | | Drift |
|---|---|---|---|---|---|---|---|---|
| | Base | Casein | Oleic | Interactions | | | | Reduction |
| | A | B | C | AB | AC | BC | ABC | (%) |
| DOE Formulation #1 | − | − | − | A + B | A + C | B + C | A + B + C | Percent |
| DOE Formulation #5 | + | − | − | A + B | A + C | B + C | A + B + C | reduction in |
| DOE Formulation #3 | − | + | − | A + B | A + C | B + C | A + B + C | cumulative |
| DOE Formulation #7 | + | + | − | A + B | A + C | B + C | A + B + C | volume |
| DOE Formulation #2 | − | − | + | A + B | A + C | B + C | A + B + C | % < 105 μm |
| DOE Formulation #6 | + | − | + | A + B | A + C | B + C | A + B + C | as compared |
| DOE Formulation #4 | − | + | + | A + B | A + C | B + C | A + B + C | to water. |
| DOE Formulation #8 | + | + | + | A + B | A + C | B + C | A + B + C | |
| Score | Sum ↑ | Sum ↑ | Sum ↑ | Sum ↑ | Sum ↑ | Sum ↑ | Sum ↑ | N/A |

TABLE 11
Results

| | Base | Casein | Oleic | Interactions | | | | Drift Reduction |
|---|---|---|---|---|---|---|---|---|
| | A | B | C | AB | AC | BC | ABC | (%) |
| DOE Formulation #1 | −47 | −47 | −47 | −95 | −95 | −95 | −142 | 47 |
| DOE Formulation #5 | 18 | −18 | −18 | 0 | 0 | −35 | −18 | 18 |
| DOE Formulation #3 | −52 | 52 | −52 | 0 | −103 | 0 | −52 | 52 |
| DOE Formulation #7 | 23 | 23 | −23 | 46 | 0 | 0 | 23 | 23 |
| DOE Formulation #2 | −70 | −70 | 70 | −139 | 0 | 0 | −70 | 70 |
| DOE Formulation #6 | 43 | −43 | 43 | 0 | 86 | 0 | 43 | 43 |
| DOE Formulation #4 | −65 | 65 | 65 | 0 | 0 | 129 | 65 | 65 |
| DOE Formulation #8 | 57 | 57 | 57 | 114 | 114 | 114 | 171 | 57 |
| Score | −93 | 18 | 94 | −74 | 2 | 113 | 20 | N/A |

### Evaluation of Factorial Design of Experiment Investigation:

The magnitude of the score for each variable, and the combinations of, indicates the level of influence. An increased deviation from zero indicates an increased influence on the resultant driftable fraction of the diluted formulation spray droplet distribution.

A positive or negative value correlates with a positive or negative impact associated with increasing the variable.

In terms of single component influence on spray drift, the design shows that a higher level of amine in the formulation has a detrimental effect on the spray drift reduction performance. Equally as strong is the positive influence of increasing the concentration of oleic acid.

Only a weak influence is shown by altering the concentration of casein.

The results also show that there is a very strong positive interaction between casein and oleic acid which is the main contributor to reducing the driftable fraction of spray solutions in these formulations. A moderate negative interaction between casein and increased amine content is also apparent.

The design also shows that there is no significant interaction between the amine content and the concentration of oleic acid in terms of spray drift reduction performance, and that the interaction of all three components combined is relatively weak.

It is shown that the presence of oleic acid and casein leads to a significant drift reduction potential. The magnitude of this effect is greatly influenced by the concentration of oleic acid and amine, but variation in the concentration of casein has a less significant impact. However, the interaction values confirm that the presence of casein is critical in these formulations for providing a significant drift reduction effect.

### Further Work

As casein and oleic acid in 2,4-D DMA MMA have shown good drift reduction effects, further trials were carried out to prepare and evaluate formulations containing alternative fatty acids and proteins for physical properties and spray droplet size distribution. Fatty acids of short, medium and long chain length to be evaluated with a selection of globular proteins.

### Example 7

### Alternative Materials

Fatty acids included in trials

| | | |
|---|---|---|
| C6 | Hexanoic acid | CH₃(CH₂)₄COOH short chain |
| C 9 | Pelargonic acid | CH₃(CH₂)₇COOH medium chain |
| | (nonanoic acid) | |
| C18:2 | Linoleic acid | C₁₈H₃₂O₂ long chain unsaturated |
| C18:1 | Ricinoleic acid | C₁₈H₃₄O₃ branched hydroxylated |

### Proteins Included in Trials

Sodium Caseinate
Soy Protein Isolate
Lactalbumin

Formulations were prepared that contained 500 g/L 2,4-D as the DMA MMA salt combined with 3-4 g/L protein and 180 g/L fatty acid and made to volume with water.

These trial formulations were evaluated for physical properties including analysis of the driftable fraction of their resultant spray droplet distributions upon atomisation when diluted in water at 1.4% v/v. The test results are displayed in Table 12.

TABLE 12
Composition of formulations containing alternative
fatty acids and proteins along with the resultant
drift reduction performance of the diluted solutions.

| | | | | | Driftable |
|---|---|---|---|---|---|
| 2,4-D g/L | | | | | Fraction as |
| (As the | | | | | compared to |
| DMA/MMA | | | | | that of Water |
| Salt) | Fatty Acid | g/l | Protein | g/L | (%) |
| 500 | Hexanoic Acid | 180 | Casein | 3 | −22.5 |
| 500 | Pelargonic | 180 | Casein | 3 | −60.1 |
| | Acid | | | | |
| 500 | Oleic Acid | 180 | Casein | 4 | −54.2 |
| 500 | Linoleic Acid | 180 | Casein | 3 | −51.6 |
| 500 | Ricinoleic | 180 | Casein | 3 | −57.6 |
| 500 | Oleic Acid | 180 | Sodium | 4 | −61.2 |
| | | | Caseinate | | |
| 500 | Oleic Acid | 180 | Lactalbumin | 4 | −27.9 |
| 500 | Oleic Acid | 180 | Soy Protein | 4 | −46.6 |
| | | | Isolate | | |

All C₆ to C₁₈ fatty acids when formulated with 2,4-D DMA MMA and casein resulted in a reduction in the driftable fraction of their spray droplet distributions as compared to water. These fatty acids have been shown to behave similarly to combinations of oleic acid and casein and all impart drift reduction properties.

Similarly, the use of lactalbumin, soy protein isolate or sodium caseinate in combination with oleic acid all resulted in a drift reduction performance of the diluted solutions as observed with the oleic acid and casein formulations.

As a further example, formulations #5, #6 & #7 were prepared containing 500 g/L 2,4-D as the DMA MMA salts and various amounts of oleic acid and sodium caseinate as detailed in Table 13.

These formulations are considered as replications of Formulations #1, #3 & #4 as prepared according to Table 8 but with sodium caseinate being used as a substitute for casein.

TABLE 13
Formulations #5 to #7: 2,4-D DMA MMA aqueous
formulation with oleic Acid and sodium caseinate.

| | Formulation | | Formulation | | Formulation | |
|---|---|---|---|---|---|---|
| Component | #5 | | #6 | | #7 | |
| 2,4-D acid technical | 510.20 | g | 510.20 | g | 510.20 | g |
| (98.0 wt %) | | | | | | |
| Monomethylamine (40% | 35.14 | g | 35.14 | g | 35.14 | g |
| aqueous solution) | | | | | | |
| Dimethylamine (60% | 136.0 | g | 136.0 | g | 136.0 | g |
| aqueous solution) | | | | | | |
| Sodium Caseinate | 4.0 | g | 4.0 | g | 4.0 | g |
| Oleic Acid | 250.0 | g | 180.0 | g | 150.0 | g |

| | | | |
|---|---|---|---|
| Water | To 1 L | To 1 L | To 1 L |

Preparation for Formulation #5, #6 and #7 (Formulation with Sodium Caseinate and Oleic Acid)

Formulation containing 500 g acid equivalent of 2,4-D as DMA and MMA salt, sodium caseinate, oleic acid and water was prepared. 100 g of water was added to a beaker followed by slow addition of required quantity of DMA (60% aqueous solution) and MMA (40% aqueous solution) to the beaker. Content was mixed at low agitation using an overhead stirrer. While stirring, required amount of sodium caseinate was added to the beaker. Once sodium caseinate was dissolved, 2,4-D acid technical (98.0% wt/wt) was gradually added to the beaker. After addition of all the base and 2,4-D acid technical, the content was mixed to achieve a clear solution. Oleic acid was then added to the beaker and mixed to obtain a clear solution. Mixture was transferred to 1 L volumetric flask and made to volume with water of nominal 20 ppm hardness. Resulting formulations were clear, free from visible solid particulate matter.

Note 1: The amount of alkaline base used to dissolve 2,4-D acid technical may vary due to volatile losses during manufacture. Excess bases may be required to completely neutralise 2,4-D technical material.

Formulations #5 to #7 were evaluated for physical parameters, including measured driftable fraction.

### Properties of Formulations #5, #6 and #7.

TABLE 14
Physical parameters of formulation #5 to #7.

| | Formulation | Formulation | Formulation |
|---|---|---|---|
| Property | #5 | #6 | #7 |
| Appearance | Amber | Amber | Amber |
| | coloured | coloured | coloured |
| | liquid | liquid | liquid |
| pH 1% in DI water | 6.80 | 6.91 | 6.95 |
| Density kg/L | 1.136 | 1.146 | 1.147 |
| Dilution Properties | Good in | Good in | Good in |
| (Diluted in tap water, | all water | all water | all water |
| 342, 500 and 1000 ppm) | qualities. | qualities. | qualities. |
| Driftable Fraction as | −65.5% | −61.2% | −57.0% |
| compared to that of | | | |
| water | | | |

The results showed the effectiveness of sodium caseinate and oleic acid at a range of concentrations in 2,4-D DMA MMA formulation as an in—can drift reduction system with a significant reduction in the driftable fraction for all three formulations. It was also found that formulations containing sodium caseinate have acceptable dilution properties in hard water. The properties of sodium caseinate as a co-formulant with oleic acid in 2,4-D amine formulations do not significantly differ to that of casein.

As further examples of the application of fatty acids as drift reduction additives, aqueous formulations containing 500 g/L MCPA, Dichlorprop-P, Mecoprop-P as DMA MMA salts and combinations of 2,4-D with Dichlorprop-P and 2,4-D with Mecoprop-P, (250 g/L each) as the DMA MMA salt, and combinations of Dicamba with Dichlorprop-P and Dicamba with Mecoprop-P, (250 g/L each) as the DMA MMA salt were prepared with oleic acid and sodium caseinate. The formulations were diluted to 1.4% v/v in water and subjected to spray analysis, the results are displayed in Table 15.

TABLE 15
Spray analysis results for diluted 2,4-D, MCPA, Dichlorprop-P, Mecoprop-P, 2,4-D
with Dichlorprop-P, 2,4-D with Mecoprop-P, Dicamba with Dichlorprop-P and Dicamba
with Mecoprop-P formulations containing oleic acid and sodium caseinate.

| | | | | | | | | Driftable |
|---|---|---|---|---|---|---|---|---|
| | | | | | | | | fraction as |
| | | | Dichlorprop- | Mecoprop- | Oleic | Sodium | | compared to |
| 2,4-D | Dicamba | MCPA | P | P | Acid | Caseinate | | that of water |
| (g/L) | (g/L) | (g/L) | (g/L) | (g/L) | (g/L) | (g/L) | Water | (%) |
| 500 | 0 | 0 | 0 | 0 | 180 | 4.0 | To | −63.0 |
| | | | | | | | Volume | |
| 0 | 0 | 500 | 0 | 0 | 180 | 4.0 | To | −61.2 |
| | | | | | | | Volume | |
| 0 | 0 | 0 | 500 | 0 | 180 | 4.0 | To | −65.0 |
| | | | | | | | Volume | |
| 0 | 0 | 0 | 0 | 500 | 180 | 4.0 | To | −64.0 |
| | | | | | | | Volume | |
| 250 | 0 | 0 | 250 | 0 | 180 | 4.0 | To | −65.0 |
| | | | | | | | Volume | |
| 250 | 0 | 0 | 0 | 250 | 180 | 4.0 | To | −59.0 |
| | | | | | | | Volume | |
| 0 | 250 | 0 | 250 | 0 | 180 | 4.0 | To | −55.0 |
| | | | | | | | Volume | |
| 0 | 250 | 0 | 0 | 250 | 180 | 4.0 | To | −54.0 |
| | | | | | | | Volume | |

The drift reduction system comprising of oleic acid and sodium caseinate has been shown to have equal performance when formulated in an MCPA, dichlorprop-P and Mecoprop-P concentrates as it does when formulated into a 2,4-D concentrate. Various combinations of 2,4-D, dicamba, dichlorprop-P and Mecoprop-P comprising oleic acid and sodium caseinate have also shown a good drift reduction performance.

### Abbreviations

MMA-monomethyl amine salt
DMA-dimethyl amine salt.

The DMA MMA salt referred to in the examples represents the acid pesticide in the form of a mixture of the salts. The DMA MMA generally refers to a salt containing a molar ratio of about 4:1.

### Example 8

This example compares the influence of the quantity of fatty acid of up to 0.1 wt % reported as providing foam control in CN 102696611 with compositions of the invention comprising at least 5 g/L fatty acid.

TABLE 16
Part 1 - Compositions based on amount of up to
0.1 wt % fatty acid disclosed in CN 102696611 A

| | Formulation with | | | Formulation with | | |
|---|---|---|---|---|---|---|
| | Capric Acid | | | Oleic acid | | |
| | | | Qty in | | | Qty in |
| Components | Qty g | | % w/w | Qty g | | % w/w |
| 2,4-D acid technical | 257.36 | g | 51.47 | 257.36 | g | 51.47 |
| (97.14 wt %) | | | | | | |
| Monomethylamine (40% | 17.57 | g | 3.51 | 17.57 | g | 3.51 |
| aqueous solution) | | | | | | |
| Dimethylamine (60% | 67.99 | g | 13.60 | 67.99 | g | 13.60 |
| aqueous solution) | | | | | | |
| Capric acid | 0.50 | g | 0.1 | Nil | | |
| Oleic Acid | Nil | | — | 0.50 | g | 0.1 |
| Sodium caseinate | 10.00 | g | 2.0 | 10.00 | g | 2.0 |
| water | To 500 | g | 29.32 | To 500 | g | 29.32 |

| TOTAL | | 100% | | 100% |
|---|---|---|---|---|
| Driftable fraction as | +6% | | +42% | |
| compared to that of | | | | |
| water (%)* | | | | |

*Positive value corresponds to an increase in spray drift potential while negative value indicates reduction in spray drift potential.

TABLE 17
Part 2 - Compositions of the Invention containing at least 5 g/L fatty acid.

| | Formulation with | | | | Formulation with | | | |
|---|---|---|---|---|---|---|---|---|
| | Capric Acid | | | | Oleic Acid | | | |
| | | | Qty | Qty in | | | Qty | Qty in |
| Components | Qty | | g/L | % w/w | Qty | | g/L | % w/w |
| 2,4-D acid technical (97.14 wt %) | 257.36 | g | 514.72 | 43.88 | 257.36 | g | 514.72 | 43.66 |
| Monomethylamine (40% aqueous | 17.57 | g | 35.14 | 3.00 | 17.57 | g | 35.14 | 2.98 |
| solution) | | | | | | | | |
| Dimethylamine (60% aqueous solution) | 67.99 | g | 135.98 | 11.59 | 67.99 | g | 135.98 | 11.53 |
| Capric acid | 2.50 | g | 5.0 | 0.43 | Nil | | — | — |
| Oleic Acid | Nil | | | — | 2.50 | g | 5.0 | 0.42 |
| Sodium caseinate | 0.05 | g | 0.1 | 0.01 | 0.05 | g | 0.1 | 0.01 |
| Water volume | To 0.5 | L | To 1 L | 41.10 | To 0.5 | L | To 1 L | 41.40 |

| TOTAL | | | 100% | | | 100% |
|---|---|---|---|---|---|---|
| DENSITY (kg/L) | 1.173 | — | | 1.179 | — | |
| Driftable fraction as compared to | −20.0% | | | −56.0% | | |
| that of water (%)* | | | | | | |

Compositions of the invention show a dramatic improvement in spray drift control.

Example 9: This example compares the efficacy of compositions of the invention with several commercially available compositions.

TABLE 18
2,4-D Composition of the Invention

| | Formulation | | Formulation | | Formulation | |
|---|---|---|---|---|---|---|
| Component | #8 | | #9 | | #10 | |
| Reference code | NUL3281 | | NUL3312 | | NUL3303 | |
| 2,4-D acid technical | 510.20 | g | 510.20 | g | 510.20 | g |
| (98.0 wt %) | | | | | | |
| Monomethylamine (40% | 35.14 | g | 35.14 | g | 35.14 | g |
| aqueous solution) | | | | | | |
| Dimethylamine (60% | 136.0 | g | 136.0 | g | 136.0 | g |
| aqueous solution) | | | | | | |
| Casein | 4.0 | g | 4.0 | g | 4.0 | g |
| Oleic acid | 250.0 | g | 180.0 | g | 150.0 | g |
| Water | To 1 | L | To 1 | L | To 1 | L |

TABLE 19
Commercial Comparison Product (CC1)

| 2,4-D acid technical (98%) | 714.29 | g |
|---|---|---|
| MMA (40%) | 47.51 g (+7 g excess) | |
| DMA (60%) | 190.05 g (+29 g excess) | |
| Acid casein | 4.0 | g |
| Water | To 1 | L |

| | |
|---|---|
| Density (20° C) | 1.234 |
| pH (1% in DI water) | 9-10 |

TABLE 20
Commercial comparison (CC2)

| 2,4-D acid present as | 668.62 g/L (456 g/L acid |
|---|---|
| choline salt | equivalent) |
| Density (20° C) | 1.185 |
| pH (1% in DI water) | 5.23 |

TABLE 21
Commercial Comparison Product (CC3)

| | |
|---|---|
| 2,4-D acid present as choline salt | 24.4% |
| Glyphosate DMA Salt | 22.1% |
| Propylene glycol | 6.4% |
| Balance | 47.1% |
| Density (20° C) | 1.1676 |
| pH (1% in DI water) | 6.17 |

TABLE 22
Commercial Standard Glyphosate Product (CC4)

| | | |
|---|---|---|
| Glyphosate IPA Salt | 400.80 | g/L |
| Glyphosate K Salt | 297.75 | g/L |
| Balance | 601.45 | g/L |

| | |
|---|---|
| Density (20° C) | 1.2216 |
| pH (1% in DI water) | 4.98 |

TABLE 23
Trial descriptions

| | | | Spray | | | | |
|---|---|---|---|---|---|---|---|
| Trial ID | Type | Rates | Volume | Species | Plant size | | Analysis |
| GHT-BE- | Greenhouse | 8 rates | 105 L/ha | Silybum | 10 | cm | D-R |
| | screen | | | marianum | 2-3 leaf | | analysis |
| | | | | Brassica napus | | | |
| FT-BE- | Field Trial | 4 rates | 100 L/ha | Tribulus | 4-60 | cm | Factorial |
| FALLOWQLD- | | | | terrestris | | | Analysis |
| FT-BE- | Field Trial | 4 rates | 100 L/ha | Amaranthus | 10 | cm | Factorial |
| FALLOW- | | | | mitchellii | | | Analysis |
| NSW | | | | Tribulus | | | |
| | | | | micococcus | | | |
| FT-BE CS- | Field Trial | 4 rates | 100 L/ha | Rhaphanus | 3-30 | cm | Factorial |
| WHEAT-QLD | | | | rhaphanistrum | | | Analysis |
| FT-BE CS- | Field Trial | 4 rates | 100 L/ha | Rhaphanus | GS14-16 | | Factorial |
| WHEAT-SA | | | | rhaphanistrum | | | Analysis |
| FT-BE-A- | Field Trial | 4 rates | 100 L/ha | Amaranthus | 6-leaf | | Factorial |
| WHEAT-ND | | | | retroflexus | 12 | cm | Analysis |
| | | | | Bassia scoparia | 10 | cm | |
| | | | | Chenapodium | 5 | cm | |
| | | | | quinoa | | | |
| | | | | Chenapodium | | | |
| | | | | album | | | |
| FT-BE-A- | Field Trial | 4 rates | 100 L/ha | Chenapodium | 30 | cm | Factorial |
| WHEAT-ND2 | | | | album | high | | Analysis |
| FT-BE-A-Arg- | Field Trial | 4 rates | 130 L/ha | Portulaca | 25 | cm | Factorial |
| Corn | | | | oleracea | | | Analysis |
| FT-BE-B- | Field Trial | 4 rates | 100 L/ha | Echinochloa | 1-5 tiller | | Factorial |
| FALLOW-QLD | With | | | colona | 1-2 | | Analysis |
| | Glyphosate | | | Cicer arietinum | branches | | |
| | | | | Hibiscus trionum | 5-12 leaf | | |
| FT-BE-B- | Field Trial | 4 rates | 100 L/ha | Dysphania | 90 | cm | Factorial |
| FALLOW-SA | With | | | pumilio | 50 | cm | Analysis |
| | Glyphosate | | | Malva parviflora | 70 | cm | |
| | | | | Citrullus lanatus | | | |
| FT-BE-B-Arg- | Field Trial | 4 rates | 130 L/ha | Amaranthus | 10 | cm | Factorial |
| Corn | With | | | quitensis | high | | |
| | Glyphosate | | | Portulaca | 25 | cm | Analysis |
| | | | | oleracea | | | |

Greenhouse trials were treated in a track sprayer. Small plot field trials were treated using hand-held spray booms.
Formulations were compared across numerous rates (8 for greenhouse & 4 for field trials).
Treatments were prepared to deliver equivalent rates across all formulations in a trial.
Improved efficacy of the formulations was noted

### 2,4-D Results (GHT-BE)

Objective: Dose-response bio-efficacy assay on 2 species of potted seedlings.

### Results:

Mean fresh weights (7 replicates) of 8-rate dose-response treatments were averaged for all formulations.

Factorial analysis of variance was used to analyse the results.

There was a clear response to rate when data was averaged across all formulations and for each formulation individually.

TABLE 24

| | 50-100-200-300-400-600-900-1200 g ae/ha | | | |
|---|---|---|---|---|
| | Silybum marianum | | Brassica napus | |
| | Fresh weight (g) | | Fresh weight (g) | |
| Formulation | 23DAA | | 23DAA | |
| Formulation #9 | 6.45 | ab | 8.74 | b |
| Formulation #8 | 5.52 | c | 7.49 | b |
| Formulation #10 | 6.19 | bc | 8.22 | b |
| CC1 | 6.09 | bc | 11.61 | a |
| CC2 | 7.04 | a | 11.23 | a |

Formulations containing Oleic acid (15%-25%) were as efficacious as CC1 when applied to Silybum marianum seedlings.
Formulations containing Oleic acid (15%-25%) were more efficacious than CC1 & CC2 when applied to Brassica napus seedlings.

### Dose-Response Analysis:

Mean % control (7 replicates) of 8-rate dose-response treatments were analysed for all formulations.

Probit-least squares method

TABLE 25

| | | 95% | | | 95% | | | |
|---|---|---|---|---|---|---|---|---|
| | | confidence | | | confidence | | | |
| | LD₅₀ | limits | | LD₉₀ | limits | | | Chi |
| Formulation | (g ae/ha) | for LD₅₀ | | (g ae/ha) | for LD₉₀ | | Equation | Squared |
| Formulation | 156 | 149 | 164 | 623 | 575 | 681 | Y = −0.322 + | 569 |
| #9 | | | | | | | 2.1324X | |
| Formulation | 123 | 118 | 128 | 333 | 314 | 353 | Y = −1.1997 + | 183 |
| #8 | | | | | | | 2.9666X | |
| Formulation | 137 | 131 | 143 | 450 | 423 | 480 | Y = −0.2961 + | 132 |
| #10 | | | | | | | 2.4795X | |
| CC1 | 209 | 201 | 217 | 669 | 633 | 710 | Y = −0.8779 + | 68 |
| | | | | | | | 2.5339X | |
| CC2 | 218 | 205 | 231 | 1656 | 1440 | 1941 | Y = −1.55998 + | 603 |
| | | | | | | | 1.4544X | |

The results show that:
The LD₅₀ for formulations containing Oleic acid was significantly lower than for CC1 & CC2.
The LD₉₀ for formulations containing Oleic acid was significantly lower than for CC2.
The LD₉₀ for formulations containing Oleic acid was lower or equivalent to CC1

### FT-BE-A-FALLOW-QLD

Objective: 4-rate response efficacy trial on Tribulus terrestris.

### Results:

Mean % control (4 replicates) of 4-rate dose-response treatments were averaged for all formulations.

Factorial analysis of variance was used to analyse the results.

There was a clear response to rate when data was averaged across all formulations and for each formulation individually.

TABLE 26

| | 269-538-795-1077 g ae/ha | | | | | |
|---|---|---|---|---|---|---|
| | Tribulus | | Tribulus | | Tribulus | |
| | terrestris | | terrestris | | terrestris | |
| | % CONTROL | | % CONTROL | | % CONTROL | |
| Formulation | 7 DA-A | | 14 DA-A | | 20 DA-A | |
| Formulation #8 | 82 | a | 99.9t | a | 99 | a |
| Formulation #10 | 76 | b | 99.7t | a | 99 | a |
| CC1 | 69 | c | 94.7t | b | 90 | b |

Formulations containing Oleic acid were more effective than CC1 on Tribulus terrestris.
Formulations containing Oleic acid resulted in higher levels of early control than CC1 on Tribulus terrestris.

### FT-BE-A-FALLOW-NSW

Objective: 4-rate response efficacy trial on 2 species

### Results:

Mean % control (4 replicates) of 4-rate dose-response treatments were averaged for all formulations.

Factorial analysis of variance was used to analyse the results.

There was a clear response to rate when data was averaged across all formulations and for each formulation individually.

TABLE 27

| | 269-538-795-1077 g ae/ha | | | | | | | |
|---|---|---|---|---|---|---|---|---|
| | Amaranthus | | Amaranthus | | Tribulus | | Tribulus | |
| | mitchellii | | mitchellii | | micrococcus | | micrococcus | |
| | % CONTROL | | % CONTROL | | % CONTROL | | % CONTROL | |
| Formulation | 16 DA-A | | 24 DA-A | | 16 DA-A | | 24 DA-A | |
| Formulation #8 | 73 | a | 93 | a | 78 | a | 90 | a |
| Formulation #10 | 74 | a | 95 | a | 84 | a | 88 | a |
| CC1 | 52 | b | 68 | b | 51 | b | 63 | b |

Formulations containing Oleic acid were more effective than CC1 on Amaranthus mitchellii and Tribulus micrococcus

### FT-BE CS-WHEAT-QLD

### Objective: 4-Rate Response Efficacy Trial on 1 Species

### Results:

Mean % control (4 replicates) of 4-rate dose-response treatments were averaged for all formulations.

Factorial analysis of variance was used to analyse the results.

There was a clear response to rate when data was averaged across all formulations and for each formulation individually.

TABLE 28

| | 538-795-1077-2154 g ae/ha | |
|---|---|---|
| | Raphanus raphanistrum | |
| | % CONTROL | |
| Formulation | 14 DA-A | |
| Formulation #9 | 65 | ab |
| Formulation #8 | 70 | a |
| Formulation #10 | 70 | ab |
| CC1 | 62 | bc |
| CC2 | 58 | c |

Formulations containing Oleic acid were at least equally effective as CC1 on Raphanus raphanistrum.
Formulations containing Oleic acid were more effective than CC2 on Raphanus raphanistrum

### FT-BE CS-WHEAT-SA

### Objective: 4-Rate Response Efficacy Trial on 1 Species

### Results:

Mean % control (4 replicates) of 4-rate dose-response treatments were averaged for all formulations.

Factorial analysis of variance was used to analyse the results.

There was a clear response to rate when data was averaged across all formulations and for each formulation individually.

TABLE 29

| | | 538-795-1077-2154 g ae/ha | |
|---|---|---|---|
| | | Raphanus raphanistrum | |
| | | % CONTROL | |
| Code | Formulation | 56DA-A | |
| NUL3312 | Formulation #9 | 79 | bc |
| NUL3281 | Formulation #8 | 83 | a |
| NUL3303 | Formulation #10 | 80 | bc |
| NUL1972 | CC1 | 82 | ab |
| NUL3318 | CC2 | 78 | c |

Formulations containing Oleic acid were at least as effective as CC1 & CC2 in controlling Raphanus raphanistrum.

### FT-BE-A-Wheat-ND1

### Objective: 4-Rate Response Efficacy Trial on 4 Species

### Results:

Mean % control (4 replicates) of 4-rate dose-response treatments were averaged for all formulations.

Factorial analysis of variance was used to analyse the results.

There was a clear response to rate when data was averaged across all formulations and for each formulation individually.

TABLE 30

| | 540-790-1080-2150 g ae/ha | | | | | | | | | | | | | | | |
|---|---|---|---|---|---|---|---|---|---|---|---|---|---|---|---|---|
| | Amaranthus | | Amaranthus | | Bassia | | Bassia | | Chenopodium | | Chenopodium | | Chenopodium | | Chenopodium | |
| | retroflexus | | retroflexus | | scoparia | | scoparia | | quinoa | | album | | album | | album | |
| | % | | % | | % | | % | | % | | % | | % | | % | |
| | CONTROL | | CONTROL | | CONTROL | | CONTROL | | CONTROL | | CONTROL | | CONTROL | | CONTROL | |
| Formulation | 12 DA-A | | 27 DA-A | | 12 DA-A | | 27 DA-A | | 12 DA-A | | 12 DA-A | | 27 DA-A | | 59 DA-A | |
| Formulation | 87 | a | 77 | a | 62 | ab | 43 | ab | 92 | a | 75 | a | 89 | a | 85 | a |
| #9 | | | | | | | | | | | | | | | | |
| Formulation | 87 | a | 75 | ab | 70 | a | 51 | a | 92 | a | 74 | a | 89 | a | 84 | ab |
| #8 | | | | | | | | | | | | | | | | |
| Formulation | 87 | a | 76 | a | 66 | a | 43 | b | 92 | a | 74 | ab | 89 | a | 84 | ab |
| #10 | | | | | | | | | | | | | | | | |
| CC1 | 82 | b | 73 | b | 55 | b | 33 | c | 83 | b | 72 | bc | 84 | b | 81 | b |
| CC2 | 87 | a | 76 | a | 63 | ab | 43 | b | 92 | a | 71 | c | 89 | a | 86 | a |

Formulations containing Oleic acid tended to be more efficacious at early assessments than CC1 on Amaranthus retroflexus, Bassia scoparia, Chenopodium quinoa and Chenopodium album.

### FT-BE-A-Wheat-ND2

### Objective: 4-Rate Response Efficacy Trial on 1 Species

### Results:

Mean % control (4 replicates) of 4-rate dose-response treatments were averaged for all formulations.

Factorial analysis of variance was used to analyse the results.

There was a clear response to rate when data was averaged across all formulations and for each formulation individually.

TABLE 31

| | 540-790-1080-2150 g ae/ha | | | | | |
|---|---|---|---|---|---|---|
| | Chenopodium | | Chenopodium | | Chenopodium | |
| | album | | album | | album | |
| | % CONTROL | | % CONTROL | | % CONTROL | |
| Formulation | 13 DA-A | | 28 DA-A | | 49 DA-A | |
| Formulation #9 | 94 | a | 97 | a | 96 | a |
| Formulation #8 | 94 | a | 98 | a | 96 | a |
| Formulation #10 | 93 | a | 98 | a | 97 | a |
| CC1 | 78 | b | 84 | b | 82 | b |
| CC2 | 76 | b | 86 | b | 82 | b |

Formulations containing Oleic acid were more efficacious at all assessments than CC1 & CC2 on Chenopodium album.

### FT-BE-A-Arg-Corn

### Objective: 4-Rate Response Efficacy Trial on 2 Species

### Results:

Mean % control (4 replicates) of 4-rate dose-response treatments were averaged for all formulations.

Factorial analysis of variance was used to analyse the results.

There was a clear response to rate when data was averaged across all formulations and for each formulation individually.

TABLE 32

| | 269-538-795-1077 g ae/ha | | | | | | | |
|---|---|---|---|---|---|---|---|---|
| | Portulaca | | Portulaca | | Portulaca | | Portulaca | |
| | oleracea | | oleracea | | oleracea | | oleracea | |
| | % CONTROL | | % CONTROL | | % CONTROL | | % CONTROL | |
| Formulation | 7DAA | | 14DAA | | 30DAA | | 55DAA | |
| Formulation #9 | 54 | ab | 87 | b | 100 | — | 100 | — |
| Formulation #8 | 63 | a | 91 | ab | 100 | — | 100 | — |
| Formulation #10 | 48 | bc | 85 | b | 100 | — | 100 | — |
| CC1 | 42 | c | 77 | c | 100 | — | 100 | — |
| CC2 | 54 | ab | 93 | ab | 100 | — | 100 | — |

CC1 tended to be less efficacious early in the assessment period compared to formulations containing Oleic acid on Portulaca oleracea

### Tank-mix-2,4-D & Glyphosate

### FT-BE-B-FALLOW-QLD-2017

### Objective: 4-Rate Response Efficacy Trial on 3 Species.

Tank mix concentrations 2,4-D 269 g ae/ha & Glyphosate 283 g ae/ha, 2,4-D 538 g ae/ha & Glyphosate 566 g ae/ha, 2,4-D 795 g ae/ha & Glyphosate 845 g ae/ha, 2,4-D 1077 g ae/ha & Glyphosate 1133 g ae/ha were compared to the co-formulated product CC3.

### Results:

Mean % control (4 replicates) of 4-rate dose-response treatments were averaged for all tank-mix preparations.

Factorial analysis of variance was used to analyse the results.

There was a clear response to rate when data was averaged across all tank-mix preparations and for each tank-mix preparation individually.

There was a clear response to rate for each 2,4-D formulation

TABLE 33

| | 269 & 283-538 & 566-795 & 845-1077 & 1133 g ae/ha | | | | | | | | | |
|---|---|---|---|---|---|---|---|---|---|---|
| | (2,4-D & Glyphosate) | | | | | | | | | |
| | Echinochloa | | Echinochloa | | Echinochloa | | Cicer | | Hibiscus | |
| | colona | | colona | | colona | | arietinum | | trionum | |
| | % | | % | | % | | % | | % | |
| | CONTROL | | CONTROL | | CONTROL | | CONTROL | | CONTROL | |
| Formulation | 7 DA-A | | 14 DA-A | | 21 DA-A | | 21 DA-A | | 21 DA-A | |
| Formulation | 72 | — | 69 | — | 77 | — | 90 | — | 80 | — |
| #8 + CC4 | | | | | | | | | | |
| Formulation | 71 | — | 68 | — | 74 | — | 89 | — | 83 | — |
| #10 + CC4 | | | | | | | | | | |
| CC1 + CC4 | 73 | — | 69 | — | 76 | — | 93 | — | 81 | — |
| CC3 | 76 | — | 72 | — | 78 | — | 94 | — | 86 | — |

There were no significant differences between tank-mixes in control on any of the species and the co-formulated commercial product CC2
Antagonism was not observed in any of the treatments on eudicotyledon or monocotyledon species

### FT-BE-B-FALLOW-SA

### Objective: 4-Rate Response Efficacy Trial on 3 Species.

Tank mix concentrations 2,4-D 269 g ae/ha & Glyphosate 283 g ae/ha, 2,4-D 538 g ae/ha & Glyphosate 566 g ae/ha, 2,4-D 795 g ae/ha & Glyphosate 845 g ae/ha, 2,4-D 1077 g ae/ha & Glyphosate 1133 g ae/ha were compared to the co-formulated product CC3.

### Results:

Mean % control (4 replicates) of 4-rate dose-response treatments were averaged for all tank-mix preparations.

Factorial analysis of variance was used to analyse the results.

There was a clear response to rate when data was averaged across all tank-mix preparations and for each tank-mix preparation individually.

TABLE 34

| | 269 & 283-538 & 566-795 & 845-1077 & 1133 g ae/ha | | | | | |
|---|---|---|---|---|---|---|
| | (2,4-D & Glyphosate) | | | | | |
| | Dysphania | | Dysphania | | Dysphania | |
| | pumilio | | pumilio | | pumilio | |
| | % CONTROL | | % CONTROL | | % CONTROL | |
| Formulation | 6 DA-A | | 14 DA-A | | 27 DA-A | |
| Formulation | 27 | — | 85 | — | 100 | — |
| #8 + CC4 | | | | | | |
| Formulation | 28 | — | 82 | — | 100 | — |
| #10 + CC4 | | | | | | |
| CC1 + CC4 | 25 | — | 81 | — | 100 | — |
| CC3 | 27 | — | 80 | — | 100 | — |

TABLE 35

| | 269 & 283-538 & 566-795 & 845-1077 & 1133 g ae/ha | | | | | | | | | | | |
|---|---|---|---|---|---|---|---|---|---|---|---|---|
| | (2,4-D & Glyphosate) | | | | | | | | | | | |
| | Malva | | Malva | | Malva | | Citrullus | | Citrullus | | Citrullus | |
| | parviflora | | parviflora | | parviflora | | lanatus | | lanatus | | lanatus | |
| | % | | % | | % | | % | | % | | % | |
| | CONTROL | | CONTROL | | CONTROL | | CONTROL | | CONTROL | | CONTROL | |
| Formulation | 6 DA-A | | 14 DA-A | | 27 DA-A | | 6 DA-A | | 14 DA-A | | 27 DA-A | |
| Formulation | 30 | — | 42 | — | 58 | — | 68 | a | 78 | — | 99 | — |
| #8 + CC4 | | | | | | | | | | | | |
| Formulation | 29 | — | 47 | — | 65 | — | 67 | a | 79 | — | 99 | — |
| #10 + CC4 | | | | | | | | | | | | |
| CC1 + CC4 | 26 | — | 42 | — | 57 | — | 59 | b | 72 | — | 98 | — |
| CC3 | 30 | — | 47 | — | 63 | — | 54 | c | 67 | — | 97 | — |

There were no significant differences between tank-mix preparations in control 27DAA on any of the species.

Antagonism was not observed in any of the treatments on any species.

### FT-BE-B-Arg-Corn-2017

### Objective: 4-Rate Response Efficacy Trial on 2 Species.

Tank mix concentrations 2,4-D 270 g ae/ha & Glyphosate 286 g ae/ha, 2,4-D 540 g ae/ha & Glyphosate 570 g ae/ha, 2,4-D 795 g ae/ha & Glyphosate 845 g ae/ha, 2,4-D 1080 g ae/ha & Glyphosate 1140 g ae/ha were compared to the co-formulated product CC3.

### Results:

Mean % control (4 replicates) of 4-rate dose-response treatments were averaged for all tank-mix preparations.

Factorial analysis of variance was used to analyse the results.

There was a clear response to rate when data was averaged across all tank-mix preparations and for each tank-mix preparation individually.

TABLE 36

| | 270 & 286-540 & 570-795 & 845-1080 & 1140 g ae/ha | | | | | | | |
|---|---|---|---|---|---|---|---|---|
| | (2,4-D & Glyphosate) | | | | | | | |
| | Amaranthus | | Amaranthus | | Amaranthus | | Amaranthus | |
| | quitensis | | quitensis | | quitensis | | quitensis | |
| | % CONTROL | | % CONTROL | | % CONTROL | | % CONTROL | |
| Formulation | 7DAA | | 14DAA | | 30DAA | | 55DAA | |
| Formulation | 79 | ab | 91 | — | 99 | — | 100 | — |
| #9 + CC4 | | | | | | | | |
| Formulation | 78 | ab | 88 | — | 99 | — | 100 | — |
| #8 + CC4 | | | | | | | | |
| Formulation | 85 | a | 94 | — | 99 | — | 100 | — |
| #10 + CC4 | | | | | | | | |
| CC1 + CC4 | 72 | b | 86 | — | 97 | — | 100 | — |
| CC3 | 80 | a | 92 | — | 100 | — | 100 | — |

TABLE 37

| | 270 & 286-540 & 570-795 & 845-1080 & 1140 g ae/ha | | | | | | | |
|---|---|---|---|---|---|---|---|---|
| | (2,4-D & Glyphosate) | | | | | | | |
| | Portulaca | | Portulaca | | Portulaca | | Portulaca | |
| | oleracea | | oleracea | | oleracea | | oleracea | |
| | POROL | | POROL | | POROL | | POROL | |
| | Control | | Control | | Control | | Control | |
| Formulation | 7DAA | | 14DAA | | 30DAA | | 55DAA | |
| Formulation | 83 | — | 92 | — | 98 | — | 100 | — |
| #9 + CC4 | | | | | | | | |
| Formulation | 79 | — | 94 | — | 99 | — | 100 | — |
| #8 + CC4 | | | | | | | | |
| Formulation | 82 | — | 94 | — | 99 | — | 100 | — |
| #10 + CC4 | | | | | | | | |
| CC1 + CC4 | 86 | — | 95 | — | 99 | — | 100 | — |
| CC3 | 79 | — | 93 | — | 98 | — | 100 | — |

There were no significant differences between tank-mix preparations in control on any of the species.

Antagonism was not observed in any of the treatments on either species

1-2. (canceled)

3. A method for pest control, comprising:
providing an aqueous pesticidal solution concentrate comprising a water-soluble pesticide salt in an amount of from 150 g/L to 750 g/L of the solution concentrate, based on weight of a pesticidally active ion of the water soluble pesticidal salt, and a drift reduction agent comprising (i) a protein and (ii) a fatty acid in an amount of from 5 g/L to 300 g/L of the solution concentrate;
diluting the aqueous pesticidal solution concentrate with water to provide a spray mixture;
spraying the spray mixture to apply the water-soluble pesticide salt to a locus of pests to be controlled.

4. The method of claim 3 wherein the protein is present in an amount of from 1 g/L to 20 g/L of the solution concentrate.

5. The method of claim 3 wherein the fatty acid is present in an amount in the range of from 50 g/L to 250 g/L of the solution concentrate.

6. The method of claim 3 wherein the water-soluble pesticide salt is selected from the group consisting of herbicides, plant growth regulators, and nematicides.

7. The method of claim 3, wherein the water-soluble pesticide salt is selected from a carboxylic acid salt, a phosphonic acid salt, a sulfonic acid salt or mixture thereof, and wherein the water-soluble pesticide salt comprises a salt counter ion selected from alkali metal counter ions, ammonia counter ion, amine counter ion, and mixtures thereof.

8. The method of claim 3, wherein the aqueous pesticidal solution concentrate comprises the water-soluble pesticide salt in an amount of from 300 g/L to 750 g/L based on weight of the pesticidally active ion of the water-soluble pesticidal salt.

9. The method of claim 3, wherein the fatty acid is a C₆ to C₂₂ fatty acid or salt thereof.

10. The method of claim 3 wherein the fatty acid is selected from the group consisting of oleic acid, ricinoleic acid, linoleic acid, hexanoic acid, pelargonic acid, stearic acid, salts thereof, and mixtures thereof.

11. The method of claim 3, wherein the protein is selected from casein, albumin, lactalbumin, whey protein, soy protein isolate, pea protein, cereal protein, bovine protein, or salts or combinations thereof.

12. The method of claim 3, wherein the water-soluble pesticide salt is selected from the group consisting of herbicides in the form of carboxylic acid salts and phosphoric acid salts.

13. The method of claim 3, wherein the water-soluble pesticide salt is selected from water-soluble salts of one or more selected from the group consisting of aromatic acid herbicides, organophosphorus herbicides, phenoxy alkanoic acid herbicides, aryloxy phenoxyalkanoic acid herbicides, picolinic acid herbicides, and quinolone carboxylic acid herbicides.

14. The method of claim 3, wherein the water-soluble pesticide salt comprises at least one water-soluble salt of an acid herbicide selected from the group consisting of benzoic acid herbicides, phenoxyacetic acid herbicides, phenoxy butyric acid herbicides, phenoxy propionic acid herbicides, and picolinic acid herbicides.

15. The method of claim 3, wherein the water-soluble pesticide salt comprises a water-soluble salt of at least one acid herbicide selected from the group consisting of 2,4-D, dicamba, MCPA, aminopyralid, clopyralid, picloram, halauxifen, flopyrauxifen, dichlorprop, mecoprop, dichlorprop-P, and mecoprop-P.

16. The method of claim 3, wherein the water-soluble pesticide salt is selected from water-soluble amine salts of 2,4-D, dicamba and mixtures thereof.

17. The method of claim 3, wherein the aqueous pesticidal solution concentrate is stable against precipitation and phase separation when stored at room temperature.

18. The method of claim 3, wherein the aqueous pesticidal solution concentrate has a pH of from 5.5 to 8.0 when determined as a 1% sample of solution concentrate in water.

19. The method of claim 3, wherein the aqueous pesticidal solution concentrate does not contain a surfactant.

20. The method of claim 3, wherein the fraction (volume %) of spray droplets smaller than 105 μm in diameter produced during the spraying step is lower than for a composition identical to the spray mixture except that it does not include the protein.

21. The method of claim 3, wherein the fraction (volume %) of spray droplets smaller than 105 μm in diameter produced during the spraying step is reduced by at least 18% compared to water spraying.

22. The method of claim 3, wherein the fraction (volume %) of spray droplets smaller than 105 μm in diameter produced during the spraying step is reduced by at least 44% compared to water spraying.
